(19) United States
(12) Patent Application Publication
(10) Pub. No.: US 2017/0231273 A1
(43) Pub. Date: Aug. 17, 2017

(54) METHOD AND SYSTEM FOR CONTROLLING SMOKING IN PUBLIC AREA, AND CONTROL METHOD FOR ELECTRONIC CIGARETTE

(71) Applicant: HUIZHOU KIMREE TECHNOLOGY CO., LTD., Huizhou, Guangdong (CN)

(72) Inventor: Zhiyong Xiang, Dongguan, Guangdong (CN)

(21) Appl. No.: 15/501,827

(22) PCT Filed: Aug. 7, 2014
(86) PCT No.: PCT/CN2014/083892

§ 371 Date: Feb. 4, 2017

(51) Int. Cl. A24F 47/00; G07C 9/00

(52) U.S. Cl. CPC A24F 47/002; G07C 9/00182

(57) ABSTRACT

A method and system for controlling smoking in a public area, and a control method for an electronic cigarette. The method for controlling smoking in a public area comprises the following steps: S1: a first wireless emitting device emits a first wireless signal within a predetermined range, the first wireless signal is provided with a smoking-prohibited information; S2: an electronic cigarette receiving the first wireless signal identifies information within the first wireless signal, and when the first wireless signal contains the smoking-prohibited information, the electronic cigarette performs self-locking and/or issues a first prompt message. The method prevents a user from smoking in a non-smoking area, and has advantageous effects of preventing a user from violating public rules and damaging the health of other people.

### FIELD OF THE INVENTION

The present application relates to a field of electronic cigarettes, and more particularly relates to a method and system for controlling smoking in a public area and a control method for an electronic cigarette.

### BACKGROUND OF THE INVENTION

In the prior arts, an electronic cigarette has no function of prompting or locking in the smoking-prohibited area, thus users may inadvertently enter a smoking-prohibited area to smoke, thereby unconsciously violating common rules and thus adversely affecting the users.

There is a drawback in the prior arts which has an urgent need for an improvement.

### SUMMARY OF THE INVENTION

Technical problems to be solved in the present invention is to provide a method and system for controlling smoking in a public area and a control method for an electronic cigarette, aiming at defects in the prior art.

Technical solutions of the present application for solving the technical problems are to provide a method for controlling smoking in a public area, the method comprises following steps:

S1: a first wireless transmitting device transmits a first wireless signal having a smoking-prohibited information within a predetermined range;

S2: an electronic cigarette receiving the first wireless signal identifies information in the first wireless signal, the electronic cigarette actuates self-locking and/or emits a first prompt message when the smoking-prohibited information is contained by the first wireless signal.

In the method for controlling smoking in the public area provided in the present invention, in the step S2, when the electronic cigarette determines that the first wireless signal contains the smoking-prohibited information, the electronic cigarette actuates the self-locking and emits the first prompt message until the first wireless signal is interrupted.

In the method for controlling smoking in the public area provided in the present invention, in the step S2, when the first wireless signal received by the electronic cigarette is interrupted, the electronic cigarette releases the self-locking and/or sends a second prompt message after a delay of a first predetermined time.

In the method for controlling smoking in the public area provided in the present invention, in the step S1, a size of the predetermined range is controlled by controlling transmission power of the first wireless transmitting device.

In the method for controlling smoking in the public area provided in the present invention, in the step S2, the first prompt message and/or the second prompt message is a light signal emitted from an indicator light provided on the electronic cigarette.

In the method for controlling smoking in the public area provided in the present invention, in the step S2, the first prompt message and/or the second prompt message is a vibration signal generated by a vibration motor provided in the electronic cigarette.

In the method for controlling smoking in the public area provided in the present invention, in the step S2, the first prompt message and/or the second prompt message is a voice signal issued by a voice module provided in the electronic cigarette.

In the method for controlling smoking in the public area provided in the present invention, the method further comprises following steps:

S3: a temporary smoking area is defined in the public area, and a second wireless transmitting device which is defined in the temporary smoking area transmits a second wireless signal having a release information;

S4: an electronic cigarette receiving the second wireless signal identifies information in the second wireless signal and releases the self-locking and/or emits a third prompt message when the second wireless signal contains the release information.

In the method for controlling smoking in the public area provided in the present invention, in the step S3, the method further comprises following steps:

The second wireless transmitting device emits a third wireless signal having its own position information;

An electronic cigarette that receives the third wireless signal identifies information in the third wireless signal; and

A fourth prompt message for prompting a position of the temporary smoking area is issued according to the position information, when the electronic cigarette recognizes the position information.

The present invention further provides a control method of an electronic cigarette, the control method comprises following steps:

S21: receiving a first wireless signal emitted by a first wireless transmitting device defined within a smoking-prohibited range;

S22: identifying information in the first wireless signal, the electronic cigarette actuates self-locking and/or emits a first prompt message when a smoking-prohibited information is contained by the first wireless signal.

The control method of the electronic cigarette provided in the present invention, in the step S22, when the electronic cigarette determines that the first wireless signal contains the smoking-prohibited information, the electronic cigarette actuates the self-locking and emits the first prompt message until the first wireless signal is interrupted.

The control method of the electronic cigarette provided in the present invention, the first prompt message is one or more kinds of text, graphics, or lighting information.

The control method of the electronic cigarette provided in the present invention, the method further comprises following steps:

S23: receiving a second wireless signal transmitted by a second wireless transmitting device defined in a temporary smoking area;

S24: identifying information in the second wireless signal and releases the self-locking and/or emits a third prompt message when the second wireless signal contains a release information.

The control method of the electronic cigarette provided in the present invention, the step S23 further comprises following steps:

Receiving a third wireless signal having its own position information emitted by the second wireless transmitting device which is defined in a temporary smoking area;

Identifying information in the third wireless signal; and a fourth prompt message for prompting a position of the temporary smoking area is issued according to the position information, when the position information is contained in the third wireless signal.

The present invention further provides a system for controlling smoking in a public area, the system comprises an electronic cigarette, a first wireless transmitting device and a second wireless transmitting device;

The first wireless transmitting device is configured for transmitting a first wireless signal having a smoking-prohibited information within a predetermined range;

The second wireless transmitting device is configured for transmitting a second wireless signal having a release information in a temporary smoking area, the temporary smoking area is defined in the predetermined range;

The electronic cigarette actuates self-locking and/or emits a first prompt message when the electronic cigarette receives the first wireless signal without receiving the second wireless signal and the smoking-prohibited information is identified to be contained by the first wireless signal; the electronic cigarette releases the self-locking and/or emits a third prompt message when the electronic cigarette receives the second wireless signal and identifies that the release information is contained in the second wireless signal;

The second wireless transmitting device is further configured for emitting a third wireless signal having its own position information; an electronic cigarette receives the third wireless signal and identifies the position information in the third wireless signal; and then a fourth prompt message for prompting a position of the temporary smoking area is issued according to the position information.

Applications of the method and system for controlling smoking in the public area and the control method for an electronic cigarette of the present invention have following advantages:

In the present invention, the electronic cigarette receiving the first wireless signal from the first wireless transmitting device can automatically self-lock and/or generate the first prompt information so that an user can know whether he is in the smoking-prohibited area or not, and smoking cannot be processed in the smoking-prohibited area. Therefore, the electronic cigarette has benefits to enable the user to avoid a violation of public rules or harming health of other persons.

### BRIEF DESCRIPTION OF THE DRAWINGS

The present invention will be further described with reference to the accompanying drawings and embodiments in the following.

FIG. 1 is a flow block diagram of a method for controlling smoking in a public area in a first embodiment of the present invention;

FIG. 2 is a flow block diagram of a method for controlling smoking in a public area in a second embodiment of the present invention;

FIG. 3 is a flow block diagram of a control method for an electronic cigarette in a first embodiment of the present invention;

FIG. 4 is a flow block diagram of a control method for an electronic cigarette in a second embodiment of the present invention;

FIG. 5 is a block diagram of an electronic cigarette in a system for controlling smoking in a public area in a preferred embodiment of the present invention;

FIG. 6 is a circuit principle diagram of a wireless transmitting device in a system for controlling smoking in a public area in a preferred embodiment of the present invention;

FIG. 7 is an another circuit principle diagram of a wireless transmitting device in a system for controlling smoking in a public area in a preferred embodiment of the present invention;

FIG. 8 is a circuit principle diagram of an electronic cigarette in a system for controlling smoking in a public area in a preferred embodiment of the present invention;

FIG. 9 is an another circuit principle diagram of an electronic cigarette in a system for controlling smoking in a public area in a preferred embodiment of the present invention;

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments.

FIG. 1 shows a method for controlling smoking in a public area, comprising following steps:

S1: a first wireless transmitting device transmits a first wireless signal having a smoking-prohibited information within a predetermined range;

S2: an electronic cigarette receiving the first wireless signal identifies information in the first wireless signal, the electronic cigarette actuates self-locking and/or emits a first prompt message when the smoking-prohibited information is contained by the first wireless signal.

In the present embodiment, the first wireless signal is a signal in which the smoking-prohibited information is loaded and subjected to a special encryption encoding, and a corresponding identification program is defined and stored in advance in the electronic cigarette. When the electronic cigarette actuates self-locking, a controller of the electronic cigarette shields smoking signals from a smoking switch, such as an airflow sensor, the controller no longer controls an atomizer to smoke liquid. The first prompt message may be a light signal emitted from an indicator light provided on the electronic cigarette, a vibration signal from a vibration motor provided in the electronic cigarette, or a voice signal issued by a voice module provided in the electronic cigarette, certainly, it may be a mixture of these kinds of prompt signals as well.

Preferably, a voltage regulating circuit is provided in the first wireless transmitting device, the voltage regulating circuit achieves an effect of controlling a coverage area of the first wireless signal by controlling transmission power of the first wireless transmitting device.

In the step S2, when the electronic cigarette determines that the first wireless signal contains the smoking-prohibited information, the electronic cigarette actuates the self-locking and emits the first prompt message until the first wireless signal is interrupted. When the user leaves the smoking-prohibited area, the electronic cigarette is outside the coverage area of the first wireless signal, thus the first wireless signal received is interrupted, and then the electronic cigarette self-locking is released and the first prompt information is emitted, then the user can smoke normally. Meanwhile, when the first wireless signal received by the electronic cigarette is interrupted, the electronic cigarette is delayed for a first predetermined time and then the second prompt message is issued to inform the user that smoking is allowable. The first predetermined time may be 1 s, 2 s, etc., and the specific value thereof is not limited. The second prompt message may be a light signal emitted from an indicator light provided on the electronic cigarette, a vibration signal from a vibration motor provided in the electronic cigarette, or a voice signal issued by a voice module provided in the electronic cigarette, certainly, it may be a mixture of these kinds of prompt signals as well. The indicator light may be a light-emitting diode.

In the step S1, a size of the predetermined range can be controlled by controlling the transmission power of the first wireless transmission device, which can prevent self-locking of the electronic cigarette happening outside the smoking-prohibited area or the electronic cigarette generating an erroneous cue, so as to improve the user experience.

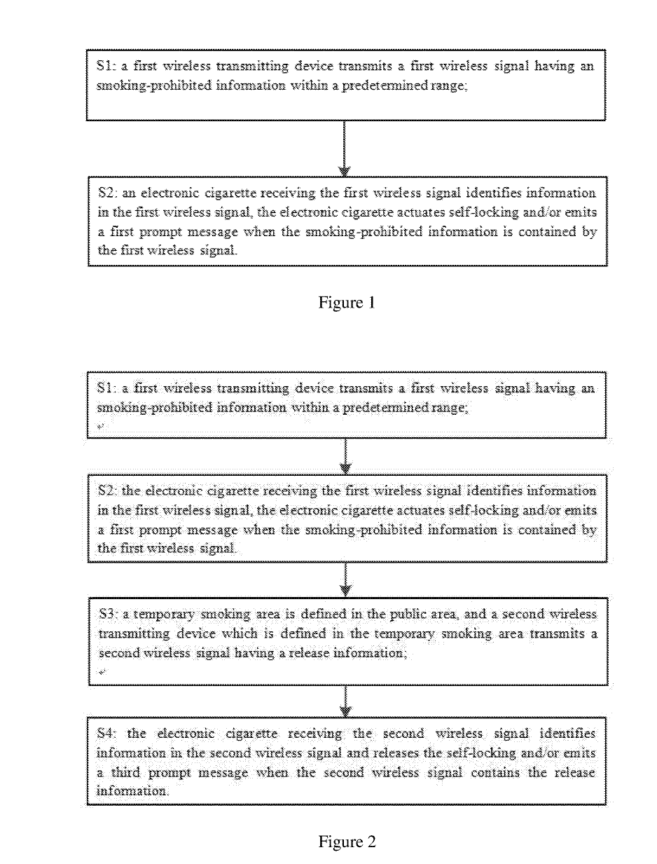

FIG. 2 shows a method for controlling smoking in a public area in a second embodiment of the present invention, comprising following steps:

S1: a first wireless transmitting device transmits a first wireless signal having a smoking-prohibited information within a predetermined range;

S2: an electronic cigarette receiving the first wireless signal identifies information in the first wireless signal, the electronic cigarette actuates self-locking and/or emits a first prompt message when the smoking-prohibited information is contained by the first wireless signal.

S3: a temporary smoking area is defined in the public area, and a second wireless transmitting device which is defined in the temporary smoking area transmits a second wireless signal having a release information;

S4: the electronic cigarette receiving the second wireless signal identifies information in the second wireless signal and releases the self-locking and/or emits a third prompt message when the second wireless signal contains the release information.

In the present embodiment, the second wireless signal is a wireless signal encrypted by a special code and loaded with the release information of the electronic cigarette. A corresponding identification program is stored in the electronic cigarette, after the electronic cigarette recognizes the release information and the electronic cigarette self-locking is released, the user can smoke normally. A coverage range of the second wireless signal can be controlled by controlling transmission power of the second wireless transmission device, which can prevent electronic cigarettes outside the temporary smoking area receiving the second wireless signal.

The third prompt message may be a light signal emitted from an indicator light provided on the electronic cigarette, a vibration signal from a vibration motor provided in the electronic cigarette, or a voice signal issued by a voice module provided in the electronic cigarette, certainly, it may be a mixture of these kinds of prompt signals as well.

The step S3 and the step S4 allow the user to select a smoking in the temporary smoking area covered with the second wireless signal, thereby improving the user experience and protecting health of other non-smokers.

The second wireless transmitting device is provided with a positioning module, for example a GPS positioning module, for acquiring position information of the second wireless transmitting device. As a preferred embodiment of the present embodiment, in the step S3, the following steps are also comprised:

The second wireless transmitting device emits a third wireless signal having its own position information;

An electronic cigarette that receives the third wireless signal identifies information in the third wireless signal; and

A fourth prompt message for prompting a position of the temporary smoking area is issued according to the position information, when the electronic cigarette recognizes the position information.

The position information may indicate the latitude and longitude of the temporary smoking area, or a general direction of the temporary smoking area. This approach can help users to find the temporary smoking area faster, so that users who want to smoke can go to the temporary smoking area for smoking, thus, it has a beneficial effect of improving the user experience. The electronic cigarette can display the position information of the temporary smoking area through a display screen or send out a voice prompt message through a voice prompt module installed in the electronic cigarette.

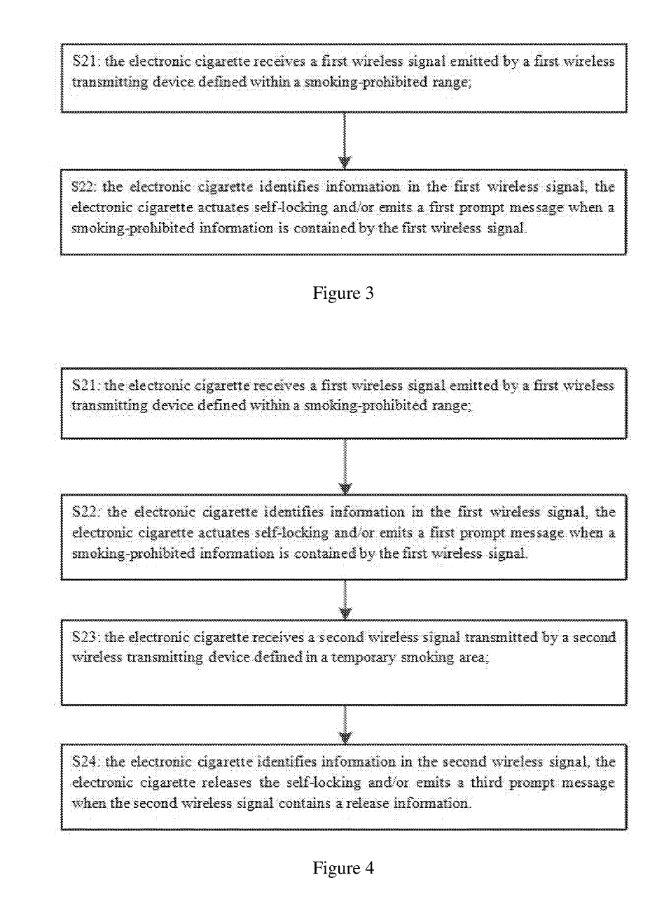

FIG. 3 shows a control method of an electronic cigarette in a first embodiment of the present invention, comprising following steps:

S21: an electronic cigarette receives a first wireless signal emitted by a first wireless transmitting device defined within a smoking-prohibited range;

S22: the electronic cigarette identifies information in the first wireless signal, the electronic cigarette actuates self-locking and/or emits a first prompt message when the smoking-prohibited information is contained by the first wireless signal.

Through the above control method of the electronic cigarette, when the user enters smoking-prohibited areas, the electronic cigarette can be self-locked, and prompts the user that he has entered the smoking-prohibited areas, so as to prevent users smoking in the smoking-prohibited areas and affecting the health of other persons or violating public regulations.

Specifically, in the step S22, when the electronic cigarette determines that the first wireless signal contains the smoking-prohibited information, the electronic cigarette actuates the self-locking and emits the first prompt message until the first wireless signal is interrupted. When the user leaves a coverage range of the first wireless signal, the electronic cigarette can no longer receives the first wireless signal, thus the electronic cigarette determines that the user has been outside the smoking-prohibited areas, then the electronic cigarette releases the self-locking and prompts the user that a normal smoking is allowable.

Understandably, the first prompt message is one or more kinds of text, graphics, or lighting information.

FIG. 4 shows a control method of an electronic cigarette in a second embodiment of the present invention, comprising following steps:

S21: an electronic cigarette receives a first wireless signal emitted by a first wireless transmitting device defined within a smoking-prohibited range;

S22: the electronic cigarette identifies information in the first wireless signal, the electronic cigarette actuates self-locking and/or emits a first prompt message when the smoking-prohibited information is contained by the first wireless signal.

S23: the electronic cigarette receives a second wireless signal transmitted by a second wireless transmitting device defined in a temporary smoking area;

S24: the electronic cigarette identifies information in the second wireless signal and releases the self-locking and/or emits a third prompt message when the second wireless signal contains a release information.

The step S23 and the step S24 define the temporary smoking area in which a smoking is allowed in the smoking-prohibited area, so that an user who wants to smoke can go to the temporary smoking area to smoke, and it has a beneficial effect of improving the user experience. The electronic cigarette can display the position information of the temporary smoking area through a display screen or send out a voice prompt message through a voice prompt module installed in the electronic cigarette.

Preferably, the step S23 further comprises following steps:

Receiving a third wireless signal having its own position information emitted by the second wireless transmitting device which is defined in a temporary smoking area;

Identifying information in the third wireless signal; and a fourth prompt message for prompting a position of the temporary smoking area is issued according to the position information, when the position information is contained in the third wireless signal.

By applying with the above steps, it can help users to find the temporary smoking area faster, it has a beneficial effect of improving the user experience. The electronic cigarette can display the position information of the temporary smoking area through a display screen or send out a voice prompt through a voice prompt module defined in the electronic cigarette.

The present invention further provides a system for controlling smoking in a public area, the system comprises several electronic cigarettes and a first wireless transmitting device and a second wireless transmitting device.

The first wireless transmitting device is configured for transmitting a first wireless signal having a smoking-prohibited information within a predetermined range.

The electronic cigarette actuates self-locking and/or emits a first prompt message when the electronic cigarette receives the first wireless signal and the smoking-prohibited information is identified to be contained by the first wireless signal, the electronic cigarette releases the self-locking and/or emits a third prompt message when the electronic cigarette receives a second wireless signal and identifies that a release information is contained in the second wireless signal.

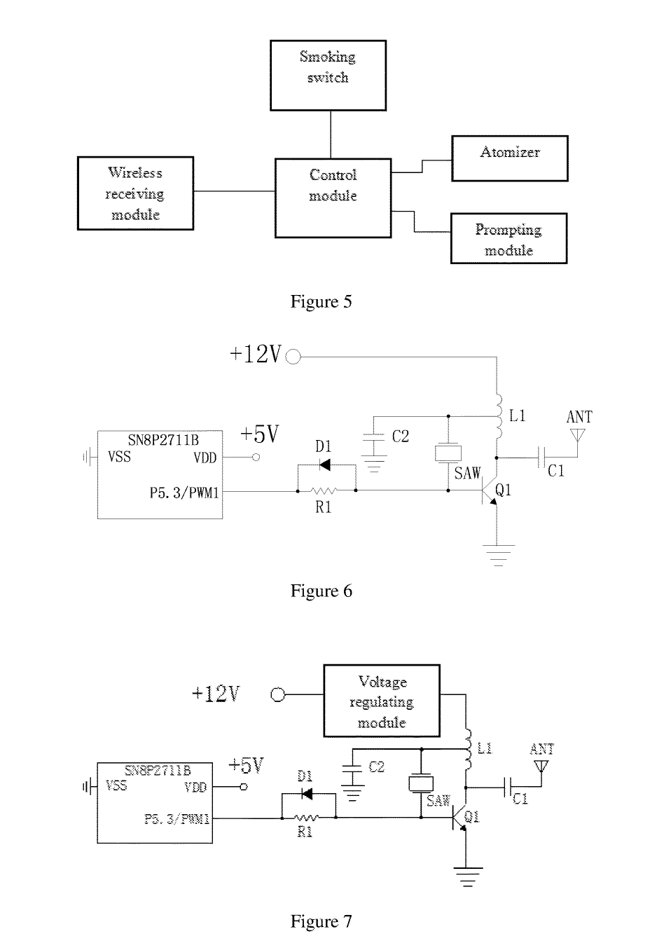

As illustrated by FIG. 5, the electronic cigarette comprises a wireless receiving module, a smoking switch, a control module, an atomizer and a prompting module.

The wireless receiving module is configured for receiving the first wireless signal sent by the first wireless transmitting device and sending the received first wireless signal to the control module. The control module identifies the first wireless signal, when the control module recognizes the smoking-prohibited information, the control module self-locks the electronic cigarette and controls the prompting module to issue the first prompt message. During the self-locking, the control module shields smoking trigger signals from the smoking switch, such as an airflow sensor, and no longer controls the atomizer to smoke oil. When the first wireless signal received by the wireless receiving module is interrupted, then it means that the user is outside the smoking-prohibited area, thus the control module releases the self-locking and controls the prompting module to issue the second prompting information so that the user can smoke normally. The prompting module may be a display screen, a LED lamp, or a vibration motor.

As shown in FIG. 6, the first wireless transmitting device comprises a control chip SN8P2711B, a first resistor R1, a first diode D1, a first capacitor C1, a second capacitor C2, an antenna, a first transistor Q1, a first inductor L1, an antenna and a crystal oscillator SAW. A pin P5.3 of the control chip SN8P2711B is electrically connected to one end of the first resistor R1, and the other end of the first resistor R1 is electrically connected to a base of the first transistor Q1 and one end of the crystal oscillator SAW, an emitter of the first transistor Q1 is grounded, and a collector of the first transistor Q1 is electrically connected to one end of the first inductor L1 and one end of the first capacitor C1, and the other end of the first capacitor C1 is connected to the antenna. The other end of the first inductor L1 is connected to a power supply. The other end of the crystal oscillator SAW and one end of the second capacitor C2 are electrically connected to a tap of the first inductor L1, and the other end of the second capacitor C2 is grounded. The control chip SN8P2711B sends a PWM signal corresponding to the wireless signal through the pin P5.3/PWM1, and the PWM signal is transmitted to the base of the first transistor Q1 through a parallel circuit of the first diode D1 and the first resistor R1, the signal is amplified by the first transistor Q1, filtered by the first capacitor C1, and then transmitted through the antenna in a form of a wireless signal.

It will be appreciated that a coverage range of the first wireless signal may be controlled by controlling transmitting power of the wireless transmit device. This can prevent electronic cigarettes from self-locking outside of the smoking-prohibited area or generating false prompts, so as to improve the user experience. As shown in FIG. 7, on the basis of the embodiment shown in FIG. 6, the first wireless transmitting device further comprises a voltage regulating circuit, a voltage is adjusted to achieve a purpose of controlling the transmitting power through the voltage regulating circuit. The voltage regulating circuit comprises a three-terminal regulator chip LM317 and its peripheral circuits, the voltage regulating circuit is a common technical means, thus it is not repeated here.

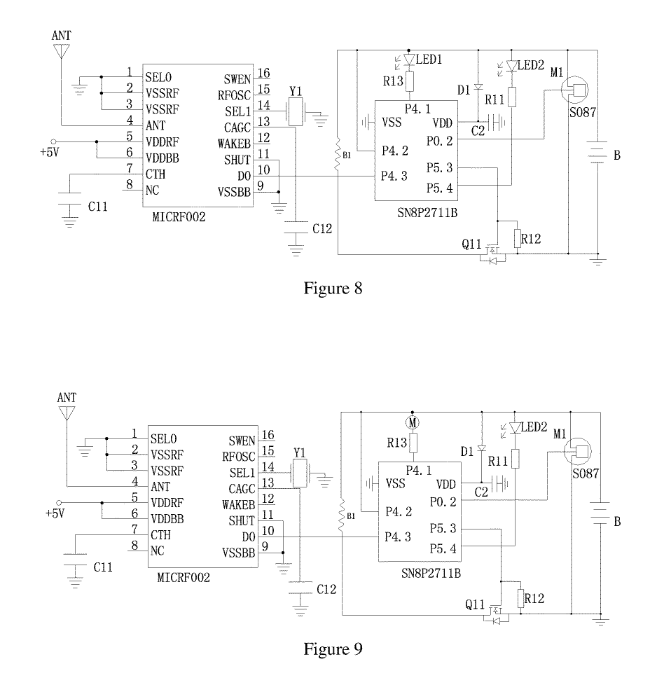

As shown in FIG. 8, a wireless receiving module comprises a chip MICRP002 and a receiving antenna. The control module can be applied with a control chip SN8P2711B. The prompting module is a light-emitting diode LED1, a negative pole of the light-emitting diode LED1 is electrically connected to a pin P4.1 of the control chip SN8P2711B through a voltage dividing resistor R3, and a positive pole of the light-emitting diode LED1 is grounded. A pin DO of the chip MICRP002 is connected to a pin P4.3 of the control chip SN8P2711B, and an airflow sensor S087 of the electronic cigarette is connected to a pin P0.2 of the control chip SN8P2711B, the airflow sensor S087 is configured for transmitting a smoking signal to the control chip SN8P2711B when an airflow is detected, the control chip SN8P2711B sends a conduction signal to a grid of an eleventh transistor Q11 based on the smoking signal so that the eleventh transistor Q11 is turned on, and the battery B is supplied heat to an electrical heating wire B1 of the atomizer to atomize smoke. When a wireless signal is received by the receiving antenna of the wireless receiving module, the wireless signal is transmitted to a pin ANT of the chip MICRP002, processed by the chip MICRP002 and then sent to the control chip SN8P2711B, when the control chip SN8P2711B recognizes the smoking-prohibited information in the wireless signal, the electronic cigarette actuates self-locking, the control chip SN8P2711B closes the pin P0.2 to shield the smoking signal generated by the airflow sensor S087, and controls the light-emitting diode LED1 to light to prompt the user until that the wireless signal is interrupted as the user leaves the smoking-prohibited area. When the control chip SN8P2711B identifies that the wireless signal contains the release information, it is indicated that the user is located in the temporary smoking area, then the control chip SN8P2711B is controlled to release the self-locking.

The prompting module can also be applied with a vibration motor M, as shown in FIG. 9, one end of the vibration motor M is electrically connected to the pin P4.1 of the control chip SN8P2711B through a voltage dividing resistor R3, while the other end of the vibration motor M is grounded. When the control chip SN8P2711B recognizes the smoking-prohibited information in the wireless signal, the electronic cigarette actuates self-locking, the control chip SN8P2711B closes the pin P0.2 to shield the smoking signal generated by the airflow sensor S087, and controls the vibration motor M to vibrate to prompt the user until that the wireless signal is interrupted as the user leaves the smoking-prohibited area.

Understandably, the system for controlling smoking in the public area can further comprises a second transmitting device. The second transmitting device is configured for covering a second wireless signal in the temporary smoking area. The second wireless signal contains the release information, an electronic cigarette receiving the second wireless signal identifies information in the second wireless signal, and the electronic cigarette releases the self-locking and/or emits a third prompt message when the release information is identified to be contained in the second wireless signal.

Understandably, the second wireless transmitting device is further configured for emitting a third wireless signal having its own position information; an electronic cigarette receives the third wireless signal and then identifies information in the third wireless signal; and a fourth prompt message for prompting a position of the temporary smoking area is issued according to the position information when the position information is identified to be contained in the third wireless signal. The fourth prompt message may be displayed through a display screen, and certainly, it may be issued by other conventional means.

Preferably, the second wireless transmitting device is further provided with a positioning module for acquiring its own position information. The second wireless transmitting device transmits a third wireless signal having its own position information. After receiving the third wireless signal and recognizing the position information therein, the electronic cigarette sends the fourth prompt message prompting a position of the temporary smoking area based on the position information.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A method for controlling smoking in a public area, wherein the method comprises following steps:
S1: transmitting, by a first wireless transmitting device, a first wireless signal having a smoking-prohibited information within a predetermined range;
S2: receiving, by an electronic cigarette, the first wireless signal identifies information in the first wireless signal, the electronic cigarette actuates self-locking and/or emits a first prompt message when the smoking-prohibited information is contained by the first wireless signal.

2. The method for controlling smoking in the public area according to claim 1, wherein in the step S2, when the electronic cigarette determines that the first wireless signal contains the smoking-prohibited information, the electronic cigarette actuates the self-locking and emits the first prompt message until the first wireless signal is interrupted.

3. The method for controlling smoking in the public area according to claim 2, wherein in the step S2, when the first wireless signal received by the electronic cigarette is interrupted, a second prompt message is sent after a delay of a first predetermined time.

4. The method for controlling smoking in the public area according to claim 3, wherein in the step S1, a size of the predetermined range is controlled by controlling transmission power of the first wireless transmitting device.

5. The method for controlling smoking in the public area according to claim 1, wherein in the step S2, the first prompt message and/or the second prompt message is a light signal emitted from an indicator light provided on the electronic cigarette.

6. The method for controlling smoking in the public area according to claim 1, wherein in the step S2, the first prompt message and/or the second prompt message is a vibration signal generated by a vibration motor provided in the electronic cigarette.

7. The method for controlling smoking in the public area according to claim 1, wherein in the step S2, the first prompt message and/or the second prompt message is a voice signal issued by a voice module provided in the electronic cigarette.

8. The method for controlling smoking in the public area according to claim 1, wherein the method further comprises following steps:
S3: a temporary smoking area is defined in the public area, and a second wireless transmitting device which is defined in the temporary smoking area transmits a second wireless signal having a release information;
S4: the electronic cigarette receiving the second wireless signal identifies information in the second wireless signal and releases the self-locking and/or emits a third prompt message when the second wireless signal contains the release information.

9. The method for controlling smoking in the public area according to claim 8, wherein in the step S3, the method further comprises following steps:
the second wireless transmitting device emits a third wireless signal having its own position information;
the electronic cigarette that receives the third wireless signal identifies information in the third wireless signal; and
a fourth prompt message for prompting a position of the temporary smoking area is issued according to the position information, when the electronic cigarette recognizes the position information.

10. A control method of an electronic cigarette, wherein the control method comprises following steps:
S21: receiving a first wireless signal emitted by a first wireless transmitting device defined within a smoking-prohibited range;
S22: identifying information in the first wireless signal, the electronic cigarette actuates self-locking and/or emits a first prompt message when a smoking-prohibited information is contained by the first wireless signal.

11. The control method of the electronic cigarette according to claim 10, wherein in the step S22, when the electronic cigarette determines that the first wireless signal contains the smoking-prohibited information, the electronic cigarette actuates the self-locking and emits the first prompt message until the first wireless signal is interrupted.

12. The control method of the electronic cigarette according to claim 11, wherein the first prompt message is one or more kinds of text, graphics, or lighting information.

13. The control method of the electronic cigarette according to claim 10, wherein the method further comprises following steps:
S23: receiving a second wireless signal transmitted by a second wireless transmitting device defined in a temporary smoking area;
S24: identifying information in the second wireless signal, the electronic cigarette releases the self-locking and/or emits a third prompt message when the second wireless signal contains a release information.

14. The control method of the electronic cigarette according to claim 12, wherein the step S23 further comprises following steps:
receiving a third wireless signal having its own position information emitted by the second wireless transmitting device which is defined in a temporary smoking area;
identifying information in the third wireless signal; and a fourth prompt message for prompting a position of the temporary smoking area is issued according to the position information, when the position information is contained in the third wireless signal.

15. A system for controlling smoking in a public area, wherein the system comprises an electronic cigarette, a first wireless transmitting device and a second wireless transmitting device;
the first wireless transmitting device is configured for transmitting a first wireless signal having a smoking-prohibited information within a predetermined range;
the second wireless transmitting device is configured for transmitting a second wireless signal having a release information in a temporary smoking area, the temporary smoking area is defined in the predetermined range;
the electronic cigarette actuates self-locking and/or emits a first prompt message when the electronic cigarette receives the first wireless signal without receiving the second wireless signal and the smoking-prohibited information is identified to be contained by the first wireless signal; the electronic cigarette releases the self-locking and/or emits a third prompt message when the electronic cigarette receives the second wireless signal and identifies that the release information is contained in the second wireless signal;
the second wireless transmitting device is further configured for emitting a third wireless signal having its own position information; the electronic cigarette receives the third wireless signal and identifies the position information in the third wireless signal; and then a fourth prompt message for prompting a position of the temporary smoking area is issued according to the position information.
